(19) United States
(12) Patent Application Publication
(10) Pub. No.: US 2021/0264691 A1
(43) Pub. Date: Aug. 26, 2021

(54) IN-VEHICLE DEVICE, SYSTEM FOR VEHICLE, AND METHOD FOR MANAGING TERMINAL CONNECTION

(71) Applicant: DENSO CORPORATION, Kariya-city (JP)

(72) Inventor: Noritaka HIRAO, Kariya-city (JP)

(21) Appl. No.: 17/170,939

(22) Filed: Feb. 9, 2021

(30) Foreign Application Priority Data
Feb. 21, 2020 (JP) 2020-028414

(51) Int. Cl. G07C 5/00; H04W 64/00; H04W 4/40; H04W 4/80

(52) U.S. Cl. CPC G07C 5/008; H04W 64/006; H04W 4/80; H04W 4/40; H04W 64/003

(57) ABSTRACT

A method uses at least one BLE module disposed on a vehicle. The method at least comprises steps (i), (ii), and (iii). (i) Performing a wireless communication by establishing a communication connection with a mobile terminal. (ii) Determining a priority order for establishing the communication connection among mobile terminals based on terminal positions determined from receiving results by the BLE module which receives radio wave transmitted from the mobile terminals. (iii) Establishing communication connection of a mobile terminal, which has a higher priority order than the others, in a prevailing manner. The priority order is determined by the priority determining step. It possible to establish communication connection of a mobile terminal of a user who is presumed to need connection more than others.

### CROSS REFERENCE TO RELATED APPLICATIONS

The present application is based on and claims the benefit of priority from Japanese Patent Application No. 2020-28414 filed in Japan filed on Feb. 21, 2020, the entire disclosure of the above application is incorporated herein by reference.

### TECHNICAL FIELD

This disclosure relates to an in-vehicle device, a system for a vehicle, and a method for managing terminal connection.

### BACKGROUND

There are devices, systems, and methods for locking and/or unlocking doors by verification procedures via invisible wireless communication. A number of communication connections between an in-vehicle device and a plurality of mobile terminals is limited depending on a system. In some application, a potential number of the mobile terminals to establish the communication connections exceeds a number of upper limit of the communication connection.

### SUMMARY

In an aspect of the disclosure, an in-vehicle device is provided. The in-vehicle device comprising: at least one processor which is configured to: establishing a plurality of communication connection with a first group of mobile terminals among a plurality of mobile terminals; performing wireless communication via the communication connections; determining a priority order among a plurality of mobile terminals, wherein the priority order is determined based on priority order determination information which is obtained by receiving radio waves transmitted from a plurality of mobile terminals by at least one antenna provided on a vehicle; and establishing a plurality of communication connection with a second group of mobile terminals including at least one mobile terminal which is different from the first group of mobile terminals and is ranked higher in the priority order than at least one of the first group of mobile terminals.

In the other aspect of the disclosure, a method is provided. The method for managing terminal connection, executed by at least one processor comprising the steps of: establishing a plurality of communication connection with a first group of mobile terminals among a plurality of mobile terminals; performing wireless communication via the communication connections; determining a priority order among a plurality of mobile terminals, wherein the priority order is determined based on priority order determination information which is obtained by receiving radio waves transmitted from a plurality of mobile terminals by at least one antenna provided on a vehicle; and establishing a plurality of communication connection with a second group of mobile terminals including at least one mobile terminal which is different from the first group of mobile terminals and is ranked higher in the priority order than at least one of the first group of mobile terminals.

According to the above configuration, it is possible to determine a priority order for establishing a communication connection among a plurality of mobile terminals based on a priority order determination information which can be used to determine the priority order. The priority order determination information is obtained by receiving radio waves transmitted from the mobile terminals by the antenna provided on the vehicle. Therefore, it is possible to determine the priority order among a plurality of mobile terminals including not only the mobile terminal now establishing the communication connection but also the mobile terminal requesting the communication connection.

The present disclosure enables a communication connection of a mobile terminal having a higher priority determined in a prevailing manner among potential terminals. Therefore, even if the substantial connectable terminal number is smaller than a number of potential users of the vehicle, it is possible to provide a communication connection to a mobile terminal which is a mobile terminal held by a user who has higher priority than that of the others. As a result, even if the substantial connectable terminal number is smaller than a number of potential users of the vehicle, it is possible to provide a communication connection to a mobile terminal, which is a mobile terminal held by a user who is assumed to need a communication connection more than the others, in a prevailing manner among potential terminals.

In order to achieve the above object, the system for vehicle of this disclosure includes a mobile terminal carried by a user, an antenna provided in the vehicle, and the above-mentioned in-vehicle device.

According to this, since the above-mentioned in-vehicle device is included, it is possible to connect a specific terminal, which is assumed a terminal of a user who needs connection via a wireless communication more than others, in a prevailing manner.

### BRIEF DESCRIPTION OF THE DRAWINGS

The disclosure is further described with reference to the accompanying drawings in which:

FIG. 1 is a block diagram showing a system for vehicles according to a first embodiment;

FIG. 2 is a block diagram showing a mobile terminal;

FIG. 3 is a block diagram showing a vehicle side unit;

FIG. 4 is a plan view showing an arrangement of BLE modules;

FIG. 5 is a block diagram showing a communication ECU;

FIG. 6 is a plan view showing a plurality of ranges;

FIG. 7 is an expression showing an example in an order of priority;

FIG. 8 is a flowchart showing processing in the communication ECU;

FIG. 9 is a block diagram showing a communication ECU of a second embodiment; and

FIG. 10 is a waveform diagram showing an example of connection processing.

### DESCRIPTION OF EMBODIMENT

A plurality of embodiments will be described for disclosure with reference to the drawings. For convenience of description, the same reference symbols are assigned to portions having the same functions as those illustrated in the drawings used in the description so far among the plurality of embodiments, and a description of the same portions may be omitted. Description in another applicable embodiment may be referred to for such a portion denoted by the identical reference symbols.

An electronic key system may perform code verification by wireless communication between an electronic key and a vehicle to lock/unlock a vehicle door and starts an engine. In such an electronic key system, it is verified whether or not the code transmitted from the electronic key matches the code of the electronic key registered in advance on the vehicle side.

Further, a sharing system may enables a use of one sharing vehicle with a plurality of mobile terminals. An authentication is performed by a terminal ID transmitted from a mobile terminal registered in advance as a vehicle key to a vehicle authentication device by short-range wireless communication. Some systems use communication compliant with Bluetooth Low Energy (BLE) (Registered Trademark).

A shared vehicle may be operated by a mobile terminal, it is assumed that there may be a demand to increase number of potential users who may use a single shared vehicle. However, in a case of a BLE-compliant short-range wireless communication, a number of terminals connectable at the same time to a single communication object may be limited. A number of terminals connectable to a single device at the same time may be referred to as a substantial connectable terminal number. In a case that a mobile terminal which perform a connection-oriented communication, in which wireless communication is performed after establishing a communication connection, the substantial connectable terminal number may be limited. Therefore, there may be a case where potential terminals which request connections at the same time exceed the substantial connectable terminal number. For example, mobile terminals more than the substantial connectable terminal number may be registered for a single vehicle. In this example, terminals requesting connections at the same time may exceed the substantial connectable terminal number. In this case, there arises a problem that at least one of mobile terminals cannot be used as electronic keys even though they are registered as vehicle keys (that is, electronic keys).

It is an object of embodiment to provide an in-vehicle device, a system for vehicle, and a method for managing terminal connection that suppresses defects caused by a number of terminals connectable at the same time.

It is an object of embodiment to provide an in-vehicle device, a system for vehicle, and a method for managing terminal connection that enables a priority connection to a necessary terminal in a prevailing manner among potential terminals, even if there are excessive number of potential terminals of which number is larger than the substantial connectable terminal number.

The above object is achieved by a combination of features described in independent claims, and sub-claims define further advantageous embodiments of the disclosure. Here, the reference numerals in parentheses described in claims indicate correspondence to the concrete means described in the embodiments, which is an example of the present disclosure. Thus, the technical scope of the present disclosure is not necessarily limited thereto.

### First Embodiment

Schematic Configuration of System 1 for Vehicle

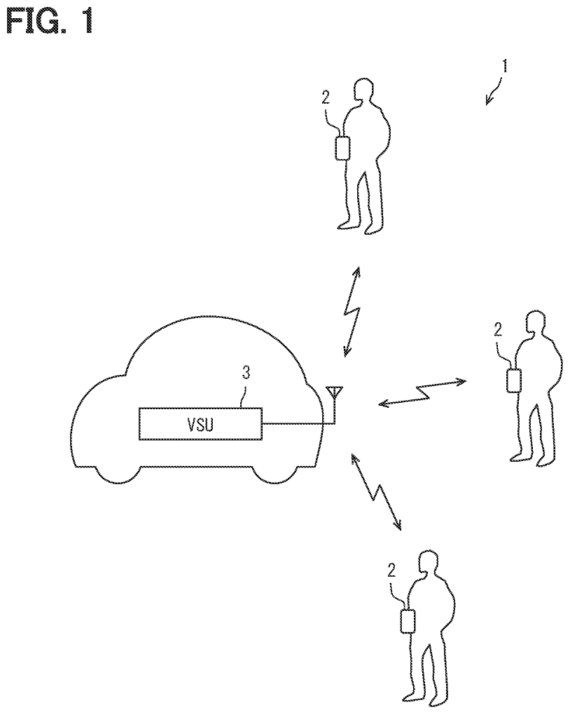

The present embodiment will now be described with reference to the drawings. First, the vehicle system 1 will be described with reference to FIG. 1. The vehicle system 1 includes a mobile terminal 2 (MOVT) and a vehicle side unit 3 (VHSU).

The mobile terminal 2 is an information processing terminal such as a multifunctional mobile phone. The mobile terminal 2 is carried by a user. Hereinafter, the following description will be given by taking the case where the mobile terminal 2 is a multifunctional mobile phone as an example. The mobile terminal 2 is not limited to a multifunctional mobile phone as long as it performs connection-oriented communication. The connection-oriented communication is a communication method in which a virtual dedicated communication path (that is, a connection) is established with a communication partner before starting wireless communication, and information is transmitted and received through the connection. That is, the connection-oriented communication is a communication method in which a wireless communication is performed while establishing a communication connection. In the connection-oriented communication, signals are exchanged to start a communication connection even before the communication connection is completely established.

The vehicle side unit 3 is used in a vehicle. This vehicle is a subject vehicle to be controlled by the mobile terminal 2. Hereinafter, this vehicle may be referred to as the subject vehicle, an own vehicle or a target vehicle. The vehicle side unit 3 performs wireless communication with the mobile terminal 2 that has established a communication connection. The vehicle side unit 3 authenticates the use of the vehicle by code verification via this wireless communication. Details of the vehicle side unit 3 will be described later. The vehicle system 1 permits vehicle control such as locking/unlocking the vehicle door and starting the traveling drive source of the vehicle based on an establishment of authentication by this code verification. That is, in the vehicle system 1, the mobile terminal 2 functions as an electronic key of the vehicle. Other examples of vehicle control permitted after authentication is established include a control of the air conditioner, or download transmission of vehicle information to the mobile terminal 2 according to an instruction from the mobile terminal 2.

The subject vehicle using the vehicle side unit 3 may be a vehicle used by a plurality of users other than the same household such as a share car. The subject vehicle may be a service vehicle such as a vehicle which is dispatched by autonomous driving or which carry out passenger transportation by autonomous driving. The share car includes a share car used for ride sharing where unfamiliar users ride together, and a share car used for renting a privately owned vehicle to another person during a not using time by a managing person of the vehicle.

Schematic Configuration of Mobile Terminal 2

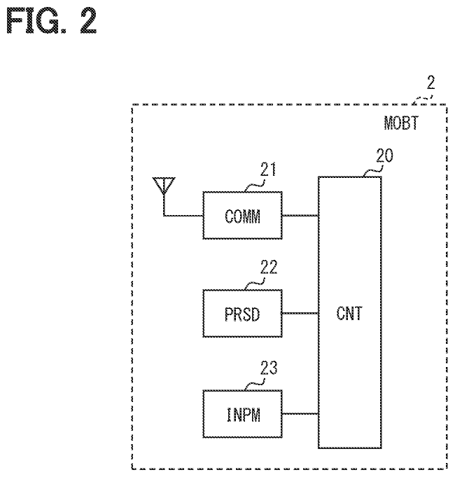

Next, the mobile terminal 2 (MOVT) will be described with reference to FIG. 2. The mobile terminal 2 includes a control unit 20 (CNT), a communication module 21 (COMM), a presentation device 22 (PRSD), and an operation input unit 23 (INPM). In the present embodiment, for convenience and easy understanding, configurations of the mobile terminal 2 related to the communication connection with the vehicle side unit 3 and the authentication for controlling the vehicle are mainly described, and the other configurations are omitted from description.

The communication module 21 is a communication module for establishing a communication connection with the vehicle side unit 3 and performing short-range wireless communication. The short-range wireless communication referred to here is, for example, communication conforming to a predetermined short-range wireless communication standard whose communication range is limited to about several tens of meters at the maximum. The predetermined short-range wireless communication standard referred to here is a communication standard in which a number of units that can be connected for communication is limited. A number of terminals that can be connected to a single device at the same time may be referred to as the substantial connectable terminal number. As this short-range wireless communication standard, Bluetooth Low Energy (hereinafter referred to as BLE) or the like can be adopted. In the present embodiment, a case where a BLE-compliant communication is performed is described as an example as the short-range wireless communication. In a BLE, radio waves in a 2.4 GHz band are used. The 2.4 GHz band includes radio waves from 2400 MHz to 2500 MHz.

The communication module 21 periodically scans and receives the advertising packet transmitted periodically from the vehicle side unit 3. The communication module 21 that has received the advertising packet transmits a connection request to the vehicle side unit 3. When this connection request is accepted, a communication connection between the communication module 21 and the vehicle side unit 3 is established. That is, the communication connection of the mobile terminal 2 to the vehicle is established.

The presentation device 22 presents information to the user. As examples of the presentation device 22, a display device that presents information by display, a voice output device that presents information by voice, and the like can be adopted. The operation input unit 23 receives operation inputs from the user. The operation input unit 23 receives operation inputs relating to requests for vehicle control from the user. This inputs may be referred to as control request operation inputs. As an example of the control request operation input, an operation input requesting lock or unlock of the vehicle door, an operation input requesting an operation of the vehicle air conditioner, an operation input requesting a down load transmission of vehicle information such as tire pressures, and the like can be adopted. The operation input unit 23 may be a touch panel integrated with the display device of the presentation device 22.

The control unit 20 includes, for example, at least one processor. The processor is configured to execute a program, which includes at least one instruction. The program may be stored in a memory, or may be configured as a circuit, i.e., wiring. In one embodiment, the control unit 20 may include at least one processor and a memory. In this configuration, the processor is capable of executing a program stored in the memory. In the other embodiment, the control circuit 20 may include at least one processor, such as a logic circuit, a GA (gate array) or an FPGA (Field Programmable Gate Array) and include no memory. In this configuration, a circuit of the processor is configured to perform specific function similar to a program. The control unit 20 may be referred to as an electronic control unit. The control unit 20 acquires information transmitted from the vehicle side unit 3 through the connection via the communication module 21 in a state where the communication connection between the vehicle side unit 3 and the communication module 21 is established. The control unit 20 acquires a signal that serves as a trigger for transmitting an authentication code from the vehicle side unit 3 through the connection, In the following, as an example, the signal that triggers the transmission of the authentication code will be described as being a random number code transmitted from the vehicle side unit 3.

When the control unit 20 acquires the random number code transmitted from the vehicle side unit 3, the control unit 20 encrypts the random number code with the private key and the encryption algorithm to generate the encryption code. The private key and encryption algorithm are the private key and encryption algorithm used in the common key cryptosystem. The control unit 20 outputs the generated encryption code to the communication module 21 as a code for code verification. The communication module 21 transmits the encryption code output from the control unit 20 to the vehicle side unit 3 for which the communication connection has been established with the communication module 21. As a result, the communication module 21 transmits the encryption code to the vehicle side unit 3 on radio waves in the 2.4 GHz band. The code for code verification may be a code distributed from the center or the like as a legitimate key information of the vehicle.

When the information acquired from the vehicle side unit 3 is the information to be presented to the presentation device 22, the control unit 20 controls the presentation device 22 to present this information. For example, when the vehicle information transmitted from the vehicle side unit 3 is acquired in response to the request for download transmission of the vehicle information, the vehicle information may be presented by the presenting device 22.

The control unit 20 may receive a control request operation input at the operation input unit 23 in a state where the communication connection between the vehicle side unit 3 and the communication module 21 is established. In this case, the control unit 20 transmits a vehicle control request corresponding to the control request operation input to the vehicle side unit 3 through the communication connection. This vehicle control request corresponds to the control request related information. As an example of the vehicle control request, a lock control request in response to an operation input which requests locking or unlocking of at least one of vehicle doors can be adopted. As an example of the vehicle control request, an air-conditioning control request corresponding to an operation input requesting an operation of the air-conditioning device of the vehicle can be adopted. As an example of the vehicle control request, a vehicle information request in response to an operation input requesting download of vehicle information such as tire pressure can be adopted. For example, the air-conditioning control request may include a request such as starting an operation and setting the air-conditioning temperature of the air-conditioning device of the vehicle.

The control unit 20 may receive a control-related operation input at the operation input unit 23 in a state where the communication connection between t5 the vehicle side unit 3 and the communication module 21 is not established. In this case, the control unit 20 may be configured to include or add information, which indicate that a vehicle control request or performing the vehicle control request, in the connection request and transmit to the vehicle side unit 3. In this case, the information, which indicates that a vehicle control request or performing the vehicle control request, correspond to the control request related information.

When it is configured that information indicating that the vehicle control request is performed is transmitted, the vehicle control request may be transmitted through the communication connection after the communication connection between the vehicle side unit 3 and the communication module 21 is established. Hereinafter, the information, which indicates that a vehicle control request or performing the vehicle control request, are collectively referred to as a vehicle control request related information.

Further, the control unit 20 may receive a transmission request of a personal seat setting from the vehicle side unit 3 which established the communication connection with the communication module 21 via the communication module 21. In this case, the control unit 20 reads out the personal seat setting of the user of the mobile terminal stored in advance in the non-volatile memory of the mobile terminal 2. Then, the control unit 20 transmits the read out personal seat setting from the communication module 21 to the vehicle side unit 3. The personal seat setting may be a set value of the seat position of the vehicle for each user.

Schematic Configuration of Vehicle Side Unit 3

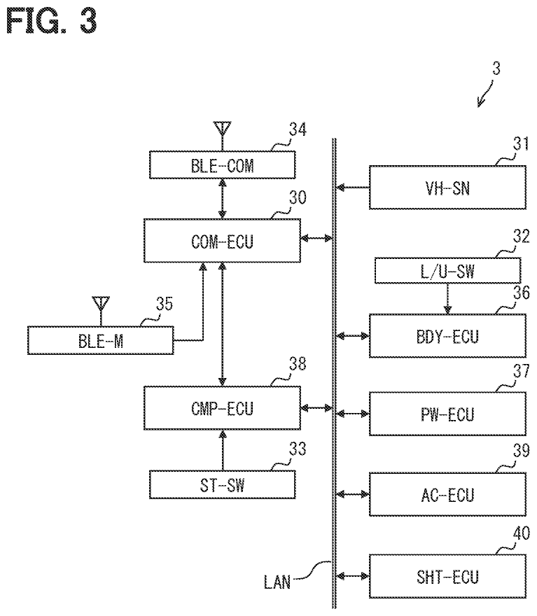

Next, an example of a schematic configuration of the vehicle side unit 3 will be described with reference to FIG. 3. The vehicle side unit 3 includes a communication ECU 30 (COM-ECU), a BLE communication unit 34 (BLE-COM), and a BLE module 35 (BLE-M). The vehicle side unit 3 includes one or more vehicle sensors 31 (VH-SN). The vehicle side unit 3 includes a lock and unlock switch (hereinafter, lock control switch) 32 (L/U-SW) and a body ECU 36 (BDY-ECU). The vehicle side unit 3 includes a start switch 33 (ST-SW) and a comparing ECU 38 (CMP-ECU), The vehicle side unit 3 includes a power unit ECU 37 (PW-ECU), an air conditioner ECU 39 (AC-ECU), and a seat ECU 40 (SHT-ECU). For example, the communication ECU 30, the vehicle sensor 31, the body ECU 36, the power unit ECU 37, the comparing ECU 38, the air-conditioner ECU 39, and the seat ECU 40 are connected to an in-vehicle LAN (LAN).

The vehicle sensor 31 is a sensor group for detecting various states of a subject vehicle. The vehicle sensor 31 may include a seating sensor which detects a human seated state of each seat in the subject vehicle. The vehicle sensor 31 may include a door courtesy switch for detecting an open or close state of the vehicle door of the subject vehicle. The vehicle sensor 31 may include additional other sensors. The vehicle sensor 31 may include a sensor to detect traveling state of the subject vehicle, and a sensor to detect a manual operating state of the subject vehicle. The vehicle sensor 31 may further include a sensor such as a vehicle speed sensor to detect a vehicle speed, a shift position sensor to detect a transmission shift position, and the like.

The lock control switch 32 is a switch for requesting lock or unlock of vehicle doors such as a driver seat door, a passenger seat door, and a trunk room door. The lock control switch 32 may be provided on an outer door handle of the vehicle or on a rear bumper. As the lock control switch 32, for example, a touch switch or a mechanical button switch can be used. A signal of the lock control switch 32 may be output to, for example, the body ECU 36.

The start switch 33 is a switch for requesting the start of the traveling drive source of the own vehicle. The start switch 33 is provided, for example, in front of the driver seat. As the start switch 33, for example, a mechanical button switch can be used. The signal of the start switch 33 may be configured to be output to, for example, the comparing ECU 38.

The BLE communication unit 34 is a communication module including, for example, an IC, an antenna, a communication circuit, and the like. The BLE communication unit 34 performs a BLE-compliant wireless communication according to an instruction from the communication ECU 30. The BLE communication unit 34 has at least an element corresponding to an antenna.

The BLE module 35 is a communication module capable of performing a BLE-compliant wireless communication. Similar to the BLE communication unit 34, the BLE module 35 may have, for example, a configuration including an IC, an antenna, a communication circuit, and the like. This BLE module 35 has at least an element corresponding to an antenna. Further, the BLE module 35 may have, for example, a configuration including an RSSI measurement circuit for measuring a reception signal strength (hereinafter, RSSI) of a received radio wave.

The BLE module 35 receives and measures an RSSI of this radio wave by sniffing (that is, intercepting) the radio wave used for wireless communication that is performed during establishing the communication connection between the communication module 21 of the mobile terminal 2 and the BLE communication unit 34. The BLE module 35 also receives and measures an RSSI of a radio wave transmitted from the communication module 21 of the mobile terminal 2 that has not established the communication connection with the BLE communication unit 34. As an example of such a radio wave, a radio wave used for transmitting a connection request before establishing a communication connection can be adopted.

It is preferable that the BLE modules 35 are provided at a plurality of locations of an inside and outside of the subject vehicle, and measure a plurality of RSSI of the radio wave transmitted from the mobile terminal 2 at each location. For example, the BLE modules 35 are arranged on, for example, an outer surface of the vehicle door, a roof of the vehicle, a bonnet, a pillar, or the like so that a predetermined range of the vehicle outside becomes a strong electric field area. Further, the BLE modules 35 are arranged on a boundary portion between a center console and an instrument panel, an inner surface of the vehicle door, a trunk room, and the like, so that a predetermined range within an inside of the vehicle becomes a strong electric field area.

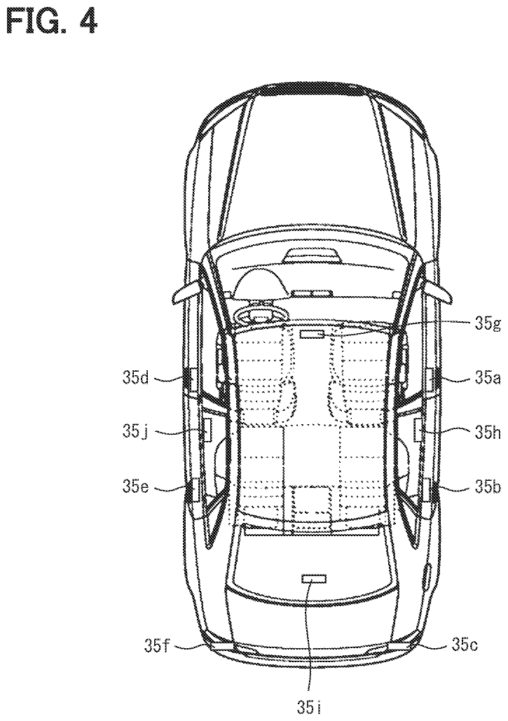

As shown in FIG. 4, the BLE module 35 includes a plurality of modules. The BLE module 35 includes a plurality of modules arranged on both the outside and the inside of the vehicle in a distributed manner. The BLE module 35 arranged on the outside may include the BLE modules 35a, 35b, 35c, 35d, 35e, and 35f. The BLE modules 35a, 35b, 35c, 35d, 35e, and 35f are distributed to left and right sides of the vehicle, and are distributed to a front, middle, and rear parts of a side surface of the vehicle. The BLE module 35 arranged on the inside of the vehicle may include the BLE modules 35g, 35h, 35i, and 35j. The BLE modules 35g, 35h, 35i, and 35j are distributed to left and right sides of the vehicle, and are distributed to front and rear sides of the vehicle. The arrangement of the BLE module 35 is an example.

The BLE module 35a is located on an outer surface of a right door of a front seat of the vehicle. The BLE module 35b is located on an outer surface of a right door of a rear seat of the vehicle. The BLE module 35c is arranged near a right corner of a rear end of the vehicle. The BLE module 35d is located on an outer surface of a left door of a front seat of the vehicle. The BLE module 35e is arranged on an outer surface of a left door of a rear seat of the vehicle. The BLE module 35f is arranged near a left corner of a rear end of the vehicle.

The BLE module 35g is arranged on a boundary portion between the center console and the instrument panel of the vehicle. The BLE module 35h is arranged on an inner surface of the right door of the rear seat. The BLE module 35i is arranged on a floor of the trunk room. The BLE module 35j is arranged on an inner surface of the left door of the rear seat.

Each BLE module 35 outputs a measured RSSI to the communication ECU 30. Since the RSSI has a distance attenuation characteristic, it is possible to calculate a distance between the BLE module 35 and the mobile terminal 2 that is a source of the radio wave from the RSSI measured by the BLE module 35. Further, the position of the mobile terminal 2 with respect to the subject vehicle can be determined from the distance between the BLE module 35 and the mobile terminal 2. In detail, a specific position of a specific mobile terminal 2 with respect to the subject vehicle can be determined from a plurality of distances between a plurality of BLE modules 35 and the specific mobile terminal 2.

For example, the position of the mobile terminal 2 with respect to a reference point of the subject vehicle can be determined by the principle of triangulation. In this case, the distances calculated from the RSSIs measured by three or more BLE modules 35 and an actual arrangement positions of the BLE modules 35 on the subject vehicle are used.

In this embodiment, a configuration for determining the positions of the mobile terminals 2 with respect to the subject vehicle by using RSSI will be described as an example. The scope of disclosure is not necessarily limited to this. For example, the position of the mobile terminal 2 with respect to the subject vehicle may be determined by using the AoA (Angle of Arrival) method in which localization is performed using an arrival angle of radio waves. Further, the position of the mobile terminal 2 with respect to the subject vehicle may be determined by using the ToF (Time of Flight) method in which localization is performed using a flight time of radio waves. In addition, the position of the mobile terminal 2 with respect to the subject vehicle may be specified by using the TDOA (Time Difference of Arrival) method in which localization is performed using an arrival time difference of radio waves.

In this disclosure, the electronic control unit includes, for example, at least one processor. The processor is configured to execute a program, which includes at least one instruction. The program may be stored in a memory, or may be configured as a circuit, i.e., wiring. In one embodiment, the control unit 20 may include at least one processor and a memory. In this configuration, the processor is capable of executing a program stored in the memory. In the other embodiment, the control circuit 20 may include at least one processor, such as a GA (gate array) or an FPGA (Field Programmable Gate Array) and include no memory. In this configuration, a circuit of the processor is configured to perform specific function similar to a program. The control unit 20 may be referred to as an electronic control unit.

The body ECU 36 is an electronic control unit including, for example, at least one processor, at least one memory, at least one I/O circuit, and at least one bus connecting them, and the like. The body ECU 36 may lock and unlock each vehicle door by transmitting a drive signal for controlling locking and unlocking of each vehicle door to a door lock motor provided in each vehicle door. Further, the body ECU 36 is connected to the lock control switch 32, and inputs a signal corresponding to on or off of the lock control switch 32.

The power unit ECU 37 is an electronic control unit including, for example, at least one processor, at least one memory, at least one I/O circuit, and at least one bus connecting them, and the like. The power unit ECU 37 controls a traveling drive source such as an internal combustion engine or a motor generator of the vehicle When the power unit ECU 37 acquires a start permission signal of the traveling drive source from the comparing ECU 38, the power unit ECU 37 starts the traveling drive source of the own vehicle.

The comparing ECU 38 is an electronic control unit including, for example, at least one processor, at least one memory, at least one I/O circuit, and at least one bus connecting them, and the like. The comparing ECU 38 performs processing related to permission to use the vehicle. The comparing ECU 38 inputs a trigger (hereinafter referred to as a request trigger) for requesting the communication ECU 30 to transmit the advertising packet according to a signal input from the body ECU 36, a vehicle state, or the like. For example, the comparing ECU 38 may input a request trigger for periodically transmitting an advertising packet to the communication ECU 30 after a certain period of time is elapsed from the vehicle is parked and all the doors of the vehicle are locked. An end timing of the periodic transmission of the advertising packet may be, for example, a timing when the vehicle starts running.

Further, the comparing ECU 38 sends a random number code, which is to be transmitted to the mobile terminal 2 established the communication connection with the vehicle, to the communication ECU 30. The communication ECU 30 controls the BLE communication unit 34 to transmit the random number code to the mobile terminal 2. The comparing ECU 38 acquires the above-mentioned encryption code transmitted from the mobile terminal 2 that has received the random number code via the BLE communication unit 34 and the communication ECU 30. Then, the comparing ECU 38 performs a code verification between an encryption code acquired from the mobile terminal 2 and an encryption code acquired by encrypting the random number code transmitted to the mobile terminal 2 with the secret key of the common key encryption method and the encryption algorithm. Alternatively, the comparing ECU 38 acquires the position of the mobile terminal 2 (hereinafter, terminal position) with respect to the subject vehicle determined by the communication ECU 30 from the communication ECU 30.

The transmission of the random number code to the mobile terminal 2 may be sequentially performed during the establishment of the communication connection between the subject vehicle and the mobile terminal 2, or may be performed when a predetermined event is detected. The predetermined event detection here includes when an operation of the lock control switch 32 is detected, when an operation of the start switch 33 is detected, when a communication connection with the subject vehicle is established, when the above-mentioned lock control request is received, and the like. The comparing ECU 38 may detect an operation of the lock control switch 32 from a signal of the lock control switch 32 input from the body ECU 36. The comparing ECU 38 may detect the operation of the start switch 33 from the signal input from the start switch 33. The collation ECU 38 may detect the establishment of the communication connection with the own vehicle and the reception of the lock control request by monitoring the communication ECU 30.

The comparing ECU 38 sends a signal to permit a lock control of each vehicle door to the body ECU 36, for example, if (i) the above-mentioned code verification is established and (ii) it is determined that the mobile terminal 2, which is used for the code verification, is located on an outside of the vehicle are established, when both (iii) the subject vehicle is parked and (iv) the vehicle door is closed are satisfied. As a result, locking and unlocking of each vehicle door is permitted. If the vehicle door is locked, the vehicle door may be permitted to be unlocked. If the vehicle door is unlocked, the vehicle door may be permitted to be locked. On the other hand, the comparing ECU 38 does not send the signal to permit a lock control of each vehicle door to the body ECU 36, if (i) the above-mentioned code verification is established, but (ii) it is not determined that the mobile terminal 2, which is used for the code verification, is located on an outside of the vehicle. In this case, locking and unlocking of each vehicle door is not permitted. The comparing ECU 38 does not send the signal to permit a lock control of each vehicle door to the body ECU 36, if (i) the above-mentioned code verification is not established. For example, a parking state of the subject vehicle is determined based on detection results detected by the vehicle speed sensor, the shift position sensor, and the like among the vehicle sensors 31. A closing state of the vehicle door is determined based on the signal of the door courtesy switch in the vehicle sensor 31. As for the position of the mobile terminal 2, the terminal position acquired from the communication ECU 30 may be used.

If it is satisfied both conditions (i) a lock control of each vehicle door is permitted and (ii) an operation of the lock control switch 32 is detected, the body ECU 36 performs lock or unlock of each vehicle door without receiving the above-mentioned lock control request. According to the above-mentioned configuration, a smart entry function may be provided. Alternatively, the body ECU 36 may be configured, if it is permitted an operation of lock or unlocking of each vehicle door when receiving the above-mentioned lock control request, to perform lock or unlock of each vehicle door without detecting an operation of the lock control switch 32. According to the above-mentioned configuration, a smart entry function may be provided.

The comparing ECU 38 sends the start permission signal of the traveling drive source to the power unit ECU 37 in response to, for example, a detection of an operation of the start switch 33, if both (i) the above-mentioned code verification is established and (ii) it is determined that the mobile terminal 2, which is used for the code verification, is located on an inside of the vehicle are established. As a result, the traveling drive source of the subject vehicle is started. On the other hand, the comparing ECU 38 does not send the start permission signal of the traveling drive source to the power unit ECU 37, if it is not determined that the mobile terminal 2, which is used for the code verification, is located on an inside of the vehicle, even if the above-mentioned code verification is established. In this case, the traveling drive source of the subject vehicle is not started. The comparing ECU 38 does not send the start permission signal of the traveling drive source to the power unit ECU 37, if the above-mentioned code verification is not established.

The air-conditioner ECU 39 is an electronic control unit including, for example, at least one processor, at least one memory, at least one I/O circuit, and at least one bus connecting them, and the like. The air-conditioner ECU 39 controls an air-conditioner that air-conditions a compartment of the vehicle. When the air-conditioner ECU 39 acquires the above-mentioned air-conditioner control request via the communication ECU 30, the air-conditioner ECU 39 operates the air-conditioner according to the air-conditioner control request. As an example of the operation of the air-conditioner according to the air conditioning control request, a start of an operation of the air-conditioner, an adjustment of the air-conditioning temperature, and the like can be adopted.

The seat ECU 40 is an electronic control unit including, for example, at least one processor, at least one memory, at least one I/O circuit, and at least one bus connecting them, and the like. The seat ECU 40 controls the seat environment such as adjusting the seat position of the seat of the vehicle. When the seat ECU 40 acquires the personal seat setting from the communication ECU 30, the seat ECU 40 adjusts the seat position of the seat to the seat position that matches the personal seat setting. As an example of the seat position to be adjusted, a reclining position, a slide position, and the like can be adopted.

The communication ECU 30 is an electronic control unit including, for example, at least one processor, at least one memory, at least one I/O circuit, and at least one bus connecting them. The communication ECU 30 is connected to, for example, the BLE communication unit 34, the BLE module 35, the comparing ECU 38, and the in-vehicle LAN. The communication ECU 30 executes various processes related to control of communication in the BLE communication unit 34. In this disclosure, the memory is a non-transitory tangible storage medium that non-temporarily stores a computer readable program and data. The non-transitory tangible storage medium is provided by a semiconductor memory, a magnetic disc, or the like. The communication ECU 30 corresponds to an in-vehicle device. The details of the communication ECU 30 will be described below.

Schematic Configuration of Communication ECU 30

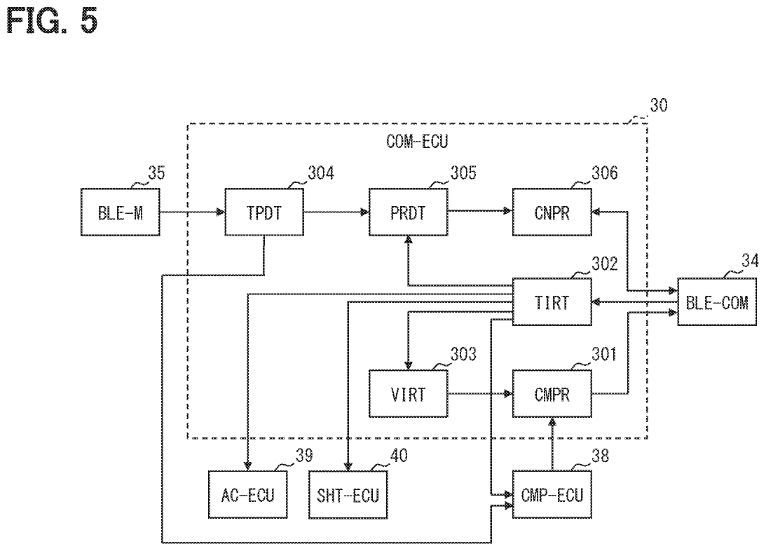

Here, a schematic configuration of the communication ECU 30 (COM-ECU) will be described with reference to FIG. 5. The communication ECU 30 includes a plurality of functional blocks. The communication ECU 30 includes a communication processing unit 301 (CMPR), a terminal information acquisition unit 302 (TIRT), and a vehicle information acquisition unit 303 (VIRT). The communication ECU 30 includes a terminal position determination unit 304 (TPDT), a priority determination unit 305 (PRDT), and a connection processing unit 306 (CNPR). In addition, a part or all of the functions executed by the communication ECU 30 may be configured as a hardware, such as one or more of ICs or the like. Alternatively, a part or all of functional blocks of the communication ECU 30 may be implemented by a combination of a software executed by at least one processor and a hardware. In this disclosure, a method may be executed by at least one processor described as the communication ECU 30. Again, at least one processor may be a processor executing a program, a processor having actual circuit corresponding to a program, or a processor having those configurations described above.

When the above-mentioned request trigger is input from the comparing ECU 38, the communication processing unit 301 starts the transmission of the advertising packet from the BLE communication unit 34. Further, the communication processing unit 301 controls the BLE communication unit 34 to transmit the random number code sent from the comparing ECU 38, to the mobile terminal 2 to which the communication connection is established. The mobile terminal 2 received the random number code returns the encryption code generated based on the random number code. In addition, the communication processing unit 301 controls the BLE communication unit 34 to transmit a transmission request of the personal seat setting, for example, to the mobile terminal 2 for which a communication connection has been established with the subject vehicle. The mobile terminal 2 that has received the transmission request of the personal seat setting returns the personal seat setting.

The terminal information acquisition unit 302 acquires the information received from the mobile terminal 2 by the BLE communication unit 34. An identification of the information for each one of the mobile terminals 2 can be distinguished based on the identification information for identifying each one of the mobile terminals 2 included in the information received from the mobile terminals 2. In the following, this identification information will be described assuming that it is a terminal ID of the mobile terminal 2. The terminal information acquisition unit 302 acquires the above-mentioned vehicle control request related information transmitted from the mobile terminal 2. When the terminal information acquisition unit 302 acquires the vehicle control request related information, the terminal information acquisition unit 302 notifies the priority determination unit 305, which will be described later, that the vehicle control request related information has been acquired.

The terminal information acquisition unit 302 sends the lock control request to the comparing ECU 38, when the terminal information acquisition unit 302 acquires the lock control request as the vehicle control request related information. As a result, the random number code is sent from the comparing ECU 38 to the communication processing unit 301. When the terminal information acquisition unit 302 acquires the air-conditioning control request as the vehicle control request related information, the terminal information acquisition unit 302 sends the air-conditioning control request to the air conditioner ECU 39. As a result, the air-conditioner ECU 39 controls the air-conditioner according to the air-conditioner control request. When the terminal information acquisition unit 302 acquires the vehicle information request as the vehicle control request related information, the terminal information acquisition unit 302 sends the vehicle information request to the vehicle information acquisition unit 303.

Further, the terminal information acquisition unit 302 acquires the personal seat setting when the BLE communication unit 34 receives the personal seat setting from the mobile terminal 2. When the terminal information acquisition unit 302 acquires the personal seat setting, the terminal information acquisition unit 302 sends the personal seat setting to the seat ECU 40. As a result, the seat ECU 40 adjusts the seat position according to the personal seat setting.

The vehicle information acquisition unit 303 acquires vehicle information according to the vehicle information request acquired by the terminal information acquisition unit 302. For example, when a vehicle information request for requesting tire pressure is acquired, the tire pressure may be acquired from a sensor unit that detects the tire pressure of the subject vehicle. When the vehicle information acquisition unit 303 acquires the vehicle information in accordance with the vehicle information request, the vehicle information acquisition unit 303 sends this vehicle information to the communication processing unit 301. Then, the communication processing unit 301 controls the BLE communication unit 34 to transmit the vehicle information to the mobile terminal 2 which is the transmission source of the vehicle information request.

The terminal position determination unit 304 determinations positions of the mobile terminals 2 with respect to the subject vehicle based on the reception results of receiving the radio waves transmitted from the mobile terminals 2 by the BLE module 35. Hereinafter the positions of the mobile terminals 2 may be referred to as terminal positions. The radio wave for obtaining the reception result used for determining the terminal position is not limited to the radio wave used for wireless communication through the communication connection between the mobile terminal 2 for which the communication connection is established with the subject vehicle and the BLE communication unit 34. For example, a radio wave used to transmit a connection request from the mobile terminal 2 whose communication connection with the vehicle is not established may be used. As a result, the terminal positions can be determined by the terminal position determination unit 304 regardless of whether the mobile terminal 2 has a communication connection with the vehicle or the mobile terminal 2 has no communication connection with the vehicle.

The terminal position determination unit 304 determines the position of the mobile terminal 2 with respect to the subject vehicle based on the reception result of receiving the radio waves transmitted from the mobile terminal 2 by each of the plurality of the BLE modules 35 provided in the subject vehicle, As an example, the position of the mobile terminal 2 with respect to the subject vehicle is determined from an RSSI of the radio waves received by each of the plurality of the BLE modules 35. The terminal position determination unit 304 may determine the position of the mobile terminal 2 with respect to the subject vehicle by using a reception result such as the RSSI of the radio wave received by the BLE communication unit 34. The terminal position determination unit 304 may determine the position of the mobile terminal 2 with respect to the subject vehicle by using the AoA method, the ToF method, the TDOA method, and the like as described above based on the reception results received by each of the plurality of the BLE modules 35. The terminal positions determined by the terminal position determination unit 304 are sent to the priority determination unit 305 and the comparing ECU 38.

The priority order determination unit 305 determines a priority order of the communication connections among the mobile terminals 2 based on the information obtained by receiving the radio waves transmitted from the mobile terminals 2 by the BLE communication units 34 and the BLE modules 35 provided in the subject vehicle. A step of determining the priority order, which is performed by the priority determination unit 305, corresponds to the priority determination step.

The priority determination unit 305 determines the priority order of the communication connection of the mobile terminal 2 according to the terminal positions determined by the terminal position determination unit 304. The terminal position determined by the terminal position determination unit corresponds to the priority order determination information.

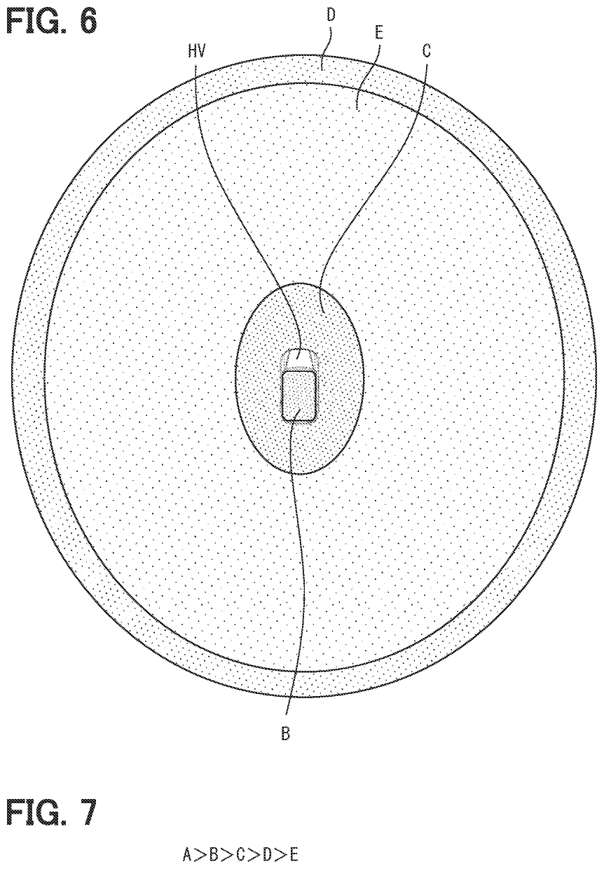

FIG. 6 shows a plurality of ranges predetermined around the subject vehicle. The HV indicates the subject vehicle. Ranges “B”, “0”, “D”, and “E” indicate ranges with respect to the subject vehicle. The range “B” indicates an inside range, i.e., within a passenger compartment, of the subject vehicle. The ranges “C”, “E” and “D” indicate outside ranges of the subject vehicle.

The range “C” indicates a vicinity range. The vicinity range is the closest outside range predetermined to surround the subject vehicle. The vicinity range is predetermined on an outside of the subject vehicle, and is a range within a first threshold circle. The first threshold circle may be defined by a first threshold distance from the subject vehicle. If a distance, which is indicated by the terminal position determined based on RSSI, from the subject vehicle to a specific mobile terminal 2 is equal to or less than the first threshold distance, this mobile terminal is located within the range “C”. The first threshold distance may be a distance that can be said to be in a vicinity of the vehicle, for example, 2 meters from the vehicle. The distance from the vehicle to the mobile terminal 2 may be a distance from the reference point of the vehicle, or may be a distance from an external surface point of the vehicle closest to the mobile terminal 2.

The range “D” indicates a boundary range, The boundary range is an outermost area for the communication connection. The mobile terminal 2 is still possible to establish the communication connection in the boundary range, but is not possible to establish the communication connection beyond the boundary range. The boundary range is more away from the vehicle than the vicinity range. The boundary range is a range corresponding to an entering range where an approaching mobile terminal 2 just begins wireless communication with the BLE communication unit 34. For example, when a possible communication range of the BLE communication unit 34 is 30 meters, the range “D” may be predetermined as an annular range having an Alpha meters width. The range “D” occupies a space between a hemisphere having a radius of 30−Alpha (30 meters minus Alpha meters) and a 30 meters hemisphere. Alpha may be predetermined a few meters.

The range “E” indicates a middle range. The middle range is predetermined between the boundary range and the vicinity range. The middle range is closer to the vehicle than the boundary range, The middle range is more away from the vehicle than the vicinity range. Hereinafter, the range “E” may be referred to as an intermediate range.

The priority order is determined based on both (i) the terminal positions of the mobile terminals 2 and (ii) a presence or absence of the reception of the vehicle control request related information.

(i) Order Depending Terminal Positions

The priority determination unit 305 determines the priority order based on the terminal positions. In the following description, if a mobile terminal 2 is on a boundary between the ranges, i.e., between the range “C” and the range “E”, or between the range “E” and the range “D”, a location of the mobile terminal 2 may be determined to either range. If a second mobile terminal 2 is located on the inside range, i.e., the range “B”, and a third, fourth or fifth mobile terminal 2 is located on outer ranges, i.e., the range “C”, “D” or “E”, the priority determination unit 305 determines the priority order so that the second mobile terminal 2 prevails the third, fourth or fifth mobile terminal 2. In this case, the priority order of the second mobile terminal 2 in the range “B” is higher than the third, fourth or fifth mobile terminal 2 in the range “C”, “D” or “E”. In this case, it is assumed that the second mobile terminal 2 in the range “B” may be used for permitting starting of the traveling drive source. Therefore, a connection needs for the second mobile terminal 2 in the range “B” is considered higher than the third, fourth, or fifth mobile terminal 2 in the range “C”, “D” or “E”. The third mobile terminal 2 in the range “C” may be used for permitting locking or unlocking the vehicle doors. However, the starting of the traveling drive source is considered more important than the locking or unlocking the vehicle doors.

If the third mobile terminal 2 is located on the vicinity range, i.e, the range “C”, and the fourth or fifth mobile terminal 2 is located on an outer range, i.e., the range “D” or “E”, the priority determination unit 305 determines the priority order so that the third mobile terminal 2 prevails the fourth or fifth mobile terminal 2. In this case, the priority order of the third mobile terminal 2 in the range “C” is higher than the fourth or fifth mobile terminal 2 in the range “D” or “E”. In this case, it is assumed that the third mobile terminal 2 in the range “C” may be used for permitting locking or unlocking the vehicle doors. Therefore, a connection needs for the third mobile terminal 2 in the range “C” is considered higher than the fourth or fifth mobile terminal 2 in the range “D” or “E”.

If the fourth mobile terminal 2 is located on the boundary range, i.e, the range “D”, and the fifth mobile terminal 2 is located on the middle range, i.e., the range “E”, the priority determination unit 305 determines the priority order so that the fourth mobile terminal 2 prevails the fifth mobile terminal 2. In this case, the priority order of the fourth mobile terminal 2 in the range “D” is higher than the fifth mobile terminal 2 in the range “E”. In this case, it is assumed that the fourth mobile terminal 2 in the range “D” may be an approaching mobile terminal 2 which may be in an appropriate timing to initiate a hospitality function by both the mobile terminal 2 and the vehicle side unit 3. Therefore, a connection needs for the fourth mobile terminal 2 in the range “D” is considered higher than the fifth mobile terminal 2 in the range “E”. The priority determination unit 305 determines the priority order based on the terminal positions. Therefore, there is a benefit that the priority of the mobile terminal 2 within the boundary range is determined higher than the priority of the mobile terminal 2 located in the middle range. As an example of the hospitality function before boarding, a welcome function can be adopted. An example of the welcome function is a seat adjustment in which the control unit 20 initiates a personal seat position adjustment to adjust variable functions of the seat to fit the user who holds the fourth mobile terminal 2 in the range “D”.

(ii) Order Depending Vehicle Control Request

Further, if the BLE communication unit 34 receives the above-mentioned vehicle control request related information, the priority determination unit 305 determines the priority order so that a first mobile terminal 2 transmitted the vehicle control request related information is the highest order among potential mobile terminals 2. The first mobile terminal 2 may be located on either one of ranges “B”, “C”, “0” or “E”. That is, the priority determination unit 305 determines and sets the highest priority order to the first mobile terminal 2 which has received the control request operation input in the operation input unit 23. The vehicle control request related information received by the BLE communication unit 34 also corresponds to information for determining the priority order. The priority determination unit 305 may handle a case where a notification that the vehicle control request related information has been acquired is received from the terminal information acquisition unit 302 as a case where the BLE communication unit 34 receives the vehicle control request related information. In this case, it is assumed that the vehicle control request related information reflects an intention of the user. Therefore, a connection needs for the mobile terminal 2 transmitted the vehicle control request related information is considered higher than the other mobile terminal 2.

Here, with reference to FIG. 7, an example of the priority order is explained. In this embodiment, the priority order is determined based on both (i) the terminal positions of the mobile terminals 2 and (ii) a presence or absence of the reception of the vehicle control request related information. If the BLE communication unit 34 receives the vehicle control request related information from a specific mobile terminal 2, then this mobile terminal 2 is ranked as a rank “A”. In other words, this mobile terminal 2 is ranked in the first rank in the priority order. If the BLE communication unit 34 does not receives the vehicle control request related information, then the priority order is determined only based on the terminal positions. If a terminal position of the mobile terminal 2 is the inside range, i.e., the range “B”, then this mobile terminal 2 is ranked as a rank “B”. In other words, this mobile terminal 2 is ranked in the second rank in the priority order. If a terminal position of the mobile terminal 2 is the vicinity range, i.e., the range “C”, then this mobile terminal 2 is ranked as a rank “C”. In other words, this mobile terminal 2 is ranked in the third rank in the priority order. If a terminal position of the mobile terminal 2 is the boundary range, i.e., the range “D”, then this mobile terminal 2 is ranked as a rank “D”. In other words, this mobile terminal 2 is ranked in the fourth rank in the priority order. If a terminal position of the mobile terminal 2 is the middle range, i.e., the range “E”, then this mobile terminal 2 is ranked as a rank “E”. In other words, this mobile terminal 2 is ranked in the fifth rank in the priority order. A predetermined priority order among the mobile terminals 2 ranked in “A” to “E” is, “A” is the highest first priority, “B” is the second priority, “C” is the third priority, “D” is the fourth priority, and “E” is the fifth priority. If five mobile terminals 2, the first mobile terminal 2 to the fifth mobile terminal 2, are located within a wireless communication available range for the communication connection, the priority order is determined in an order of first>second>third>fourth>fifth. The priority determination unit 305 also renews the priority order in order to provide an opportunity to establish a new communication connection with a new higher ranked mobile terminal 2 instead of the lowest ranked mobile terminal 2.

A plurality of the mobile terminals 2 may transmit the vehicle control request related information in an orderly manner. In this case, the priority determination unit 305 may determine the priority order so that the mobile terminal 2 of which the vehicle control request related information is newly received by the BLE communication unit 34 is ranked higher than the mobile terminal 2 of which the vehicle control request related information is previously received. Further, if there are a plurality of mobile terminals 2 having the same positional range and the same conditions regarding the vehicle control request, the priority determination unit 305 may determine the same priority order for those mobile terminals 2. For example, if a plurality of mobile terminals 2 are located within the same range, i.e., “B”, “C”, “D” or “E”, and the condition about the vehicle control request related information are the same, the priority determination unit 305 determines the same priority order for those mobile terminals 2.

In addition, the priority determination unit 305 may further divide a specific range in order to determine the priority order in a case that a plurality of mobile terminals 2 are located within the same range. For example, the inside range “B” may be divided into a driver seat range and the other seats range. In this case, the mobile terminal 2 located on the driver seat range is ranked higher than the mobile terminal 2 located on the other seats range. In this case, it is assumed that the mobile terminal 2 in the driver seat range may be used for permitting starting of the traveling drive source, Therefore, a connection needs for the mobile terminal 2 in the driver seat range is considered higher than the other mobile terminal 2 in the same range.

The priority determination unit 305 may be configured to store the determined priority order for each mobile terminal 2 in the memory of the communication ECU 30. In this case, for example, a terminal ID of the mobile terminal 2 and the priority order may be associated and stored. The memory for storing the priority order may be a volatile memory or a non-volatile memory. The priority determination unit 305 shall sequentially redetermine and renew the priority order. The priority determination unit 305 may redetermine the priority order when the terminal positions are newly determined by the terminal position determination unit 304. Further, the priority determination unit 305 may redetermine the priority order when the BLE communication unit 34 newly receives the vehicle control request related information.

The connection processing unit 306 establishes a communication connection between the BLE communication unit 34 and the mobile terminal 2 to perform wireless communication. The connection processing unit 306 permits a predetermined number (Nth) of the communication connections at the same time. The connection processing unit 306 does not permits the communication connections exceeding the predetermined number (Nth<N). The predetermined number referred to here is assumed to be a plurality, and is not 1. The connection processing unit 306 determines whether or not to accept the communication connection of the mobile terminal 2 from which the connection request has been made, based on the priority order determined by the priority determination unit 305. The connection processing unit 306 connects the mobile terminal 2 having a higher priority determined by the priority determination unit 305 for communication connection in a prevailing manner. The mobile terminal 2 having a high priority order may be the mobile terminal 2 held by a user who is presumed to need more connection than others. Therefore, according to the above configuration, it is possible to connect the mobile terminal 2 of the user, who is presumed to need connection more than others, in a prevailing manner. A connection processing step corresponds to a step performed by the connection processing unit 306 to connect the mobile terminal 2, which has a higher priority, in a prevailing manner.

The connection processing unit 306 provides processing when there is a mobile terminal that newly requests a communication connection when a number of mobile terminals 2 establishing the communication connections with the vehicle is less than the predetermined number at the same time (N<Nth), In the following description, the mobile terminal that newly requests a communication connection is called a connection request terminal. The connection processing unit 306 accepts the connection request of the connection request terminal and establishes a communication connection. The connection processing unit 306 may determine the presence or absence of the connection request by monitoring the presence or absence of the reception of the connection request in the BLE communication unit 34. As a result, the connection processing unit 306 establishes a plurality of communication connections with the mobile terminals up to the predetermined number.

The connection processing unit 306 provides processing when there is a requesting mobile terminal that newly requests a communication connection when a number of mobile terminals 2 establishing the communication connections with the vehicle reaches the predetermined number at the same time (N=Nth). The connection processing unit 306 compares ranks in the priority order of the mobile terminal 2, which now establishes the communication connection and the connection request terminal. The priority order used for comparison is the latest priority order determined by the priority determination unit 305. Then, if the mobile terminal 2 establishing the communication connection is ranked lower than the mobile terminal 2 requesting a new communication connection, the connection processing unit 306 cancels the communication connection of the lower mobile terminal 2, and establish a new communication connection with the new higher mobile terminal 2. Further, the connection processing unit 306 accepts the connection request of the connection request terminal and establish a communication connection. On the other hand, if any one of previously connected mobile terminal 2 is not ranked lower than the connection request terminal, the connection processing unit 306 rejects the connection request from the connection request terminal and does not establish a communication connection.

In some configuration, a connection request may be transmitted from the mobile terminal 2 in response to the advertisement packet transmission from the BLE communication unit 34. In this case, the above-mentioned predetermined number may be the same as the substantial connectable terminal number, even if a number of mobile terminal 2 connected to the vehicle at the same time reaches the substantial connectable terminal number. According to this, it is possible to give priority to the mobile terminal 2 of the user who is presumed to need connection more than others, and to increase the number of potential mobile terminals 2, which may be connected to a single vehicle.

On the other hand, in some configuration, a connection request cannot be transmitted from the mobile terminal 2 in response to the advertisement packet transmission completion from the BLE communication unit 34. In this case, the above-mentioned predetermined number may be set smaller than the substantial connectable terminal number. As an example, the predetermined number may be set a number obtained by subtracting 1 from the substantial connectable terminal number. According to this, even if a number of mobile terminal 2 connected to the vehicle at the same time reaches the substantial connectable terminal number, it is possible to connect a mobile terminal 2 which is held by a user who needs connection more than the others.

Connection Related Processing in Communication ECU 30

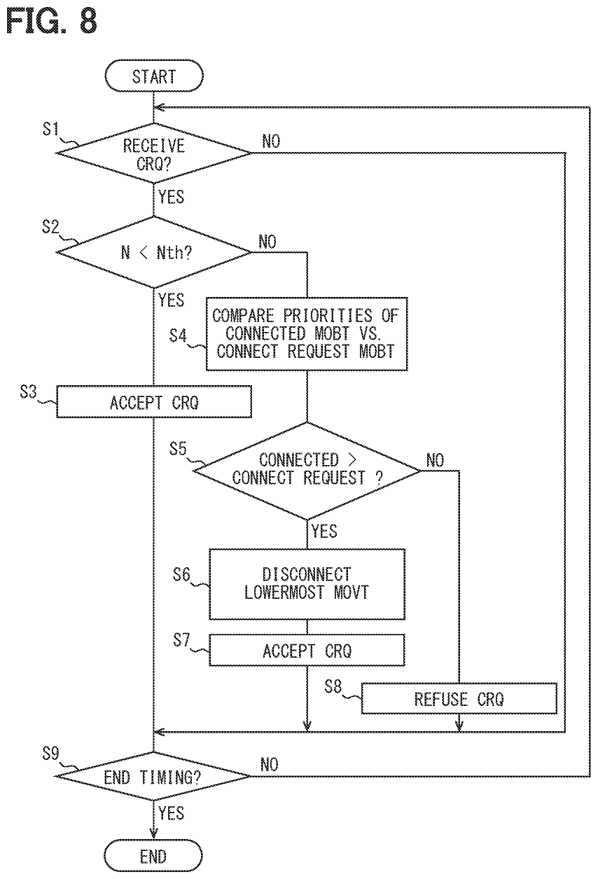

Next, the flowchart of FIG. 8 will be described. The flowchart is an example of processing related to the communication connection of the mobile terminal 2 in the communication ECU 30 (hereinafter, connection-related processing). The flowchart may be configured to start, for example, when the communication ECU 30 starts transmitting the advertising packet from the BLE communication unit 34. Further, in the flowchart, it is assumed that the priority determination unit 305 sequentially determines the priority order of the mobile terminals 2 and sequentially updates the priority order of the mobile terminals 2.

First, in step Si when the connection request (CRQ) transmitted from the mobile terminal 2 is received (YES in S1), the process proceeds to step S2. On the other hand, if the connection request has not been received (NO in S1), the process proceeds to step S9.

In step S2, if a number (N) of the mobile terminals 2, which is now establishing the communication connection to the BLE communication unit 34 of the vehicle, is smaller than the predetermined number (N<Nth) (YES in S2), the process proceeds to step S3. On the other hand, if a number of the mobile terminals 2, which is now establishing the communication connection to the BLE communication unit 34 of the vehicle, is equal to or larger than the predetermined number (N=Nth or Nth<N), (NO in S2), the process proceeds to step S4. The processing in step S2 can be expressed as N<Nth? In step S3, the connection processing unit 306 accepts the connection request. In step S3, a communication connection is established with the mobile terminal 2 (that is, the connection request terminal) that has transmitted the connection request. As a result, a plurality of communication connections with the mobile terminals up to the predetermined number is established. Subsequently, the process proceeds to step S9.

In step S4, the connection processing unit 306 compares a rank in the priority order of the mobile terminal 2 communicating with the subject vehicle with a rank in the priority order of the connection requesting terminal. In step S5, if the rank in the priority order of the connection requesting terminal is higher than the lowest rank of the priority order of the mobile terminal 2 among the mobile terminals 2 communicating with the subject vehicle (YES in S5), the process proceeds to step 36. On the other hand, when a rank in the priority order of the connection request terminal is lower (NO in S5) than the lowest rank of the priority order of the mobile terminal 2, the process proceeds to step 38.

In step S6, the connection processing unit 306 cancels the communication connection with the mobile terminal 2 having the lowest priority order among the mobile terminals 2 establishing the communication connections. In step S7, the connection processing unit 306 accepts the connection request, establishes a communication connection with the connection request terminal, and proceeds to step S9. As a result, the communication connection for the lowest ranked and previously connected mobile terminal 2 is canceled, and alternative new communication connection for a higher ranked and new mobile terminal 2 is established in a switching manner.

In step S8, the connection processing unit 306 rejects the connection request, does not establish the communication connection of the connection request terminal, and proceeds to step S9. As a result, a number of a plurality of communication connections with the mobile terminals is maintained equal to of less than the predetermined number. In step S9, if it is an end timing of the connection related processing (YES in S9), the connection related processing is finished. As an example of end timing of the connection-related processing, an end timing of a transmission of the advertising packet, a timing of turning the power of the communication ECU 30 off, or the like can be adopted. On the other hand, if it is not the end timing of the connection related processing (NO in S9), the process returns to S1 to repeat the process.

Summary of First Embodiment

According to the configuration of the first embodiment, the priority determination unit 305 determines the priority order of the communication connection of a certain mobile terminal 2 among a plurality of mobile terminals 2 according to the terminal positions of the mobile terminals 2 and the presence or absence of the reception of the vehicle control request related information. In the embodiment, the terminal position of the mobile terminal 2 determined by the terminal position determination unit 304 is determined based on the reception result of radio waves used for wireless communication through a communication connection. Alternatively, the terminal position of the mobile terminal 2 may be determined by using a reception result of a received radio wave which is used exchanging signals before establishing a communication connection. Therefore, it is possible to determine the priority order not only the mobile terminals 2, which establish the communication connections with the subject vehicle, but also the priority order of the mobile terminal 2, which requests to establish a communication connection with the subject vehicle (i.e., the mobile terminal 2 which is not established a communication connection with the own vehicle. Then, the connection processing unit 306 connects the mobile terminal 2, which has a higher priority determined by the priority determination unit 305, in a prevailing manner. Therefore, even if the substantial connectable terminal number is smaller than a number of potential users of the vehicle, it is possible to provide a communication connection to a mobile terminal 2, which is a mobile terminal 2 held by a user who has higher priority than that of the others, in a prevailing manner. As a result, even if the substantial connectable terminal number is smaller than a number of potential users of the vehicle, it is possible to provide a communication connection to a mobile terminal 2 which is a mobile terminal 2 held by a user who is assumed to need a communication connection more than the others.

### Second Embodiment

The first embodiment is configured that, after establishing a communication connection to one previous mobile terminal 2, the communication connection to the previous mobile terminal 2 is maintained until the communication connection is canceled in order to establish a new communication connection to the other one of a new mobile terminal 2, which has a higher priority order than the previous mobile terminal 2. The scope of disclosure is not necessarily limited to this. In one example, the communication connection with the mobile terminal ranked higher in the priority order may be set to maintain a connection time period longer than the other mobile terminal ranked lower in the priority order. The communication connection with the mobile terminal ranked higher in the priority order may be set to maintain a disconnection time period shorter than the other mobile terminal ranked lower in the priority order. In the other example, the higher the mobile terminal among the mobile terminals is ranked in the priority order, the longer the connection time period for the communication connection is obtained. The higher the mobile terminal among the mobile terminals is ranked in the priority order, the shorter the disconnection time period for the communication connection is obtained. As a result, it is possible to establish a configuration (hereinafter, a second embodiment) in which communication connections are made so that the number of mobile terminals 2 connected to the vehicle at the same time does not exceed the predetermined number.

Hereinafter, an example of the second embodiment will be described with reference to the drawings. The vehicle system 1 of the second embodiment is the same as the vehicle system 1 of the first embodiment except that the communication ECU 30a is included instead of the communication ECU 30.

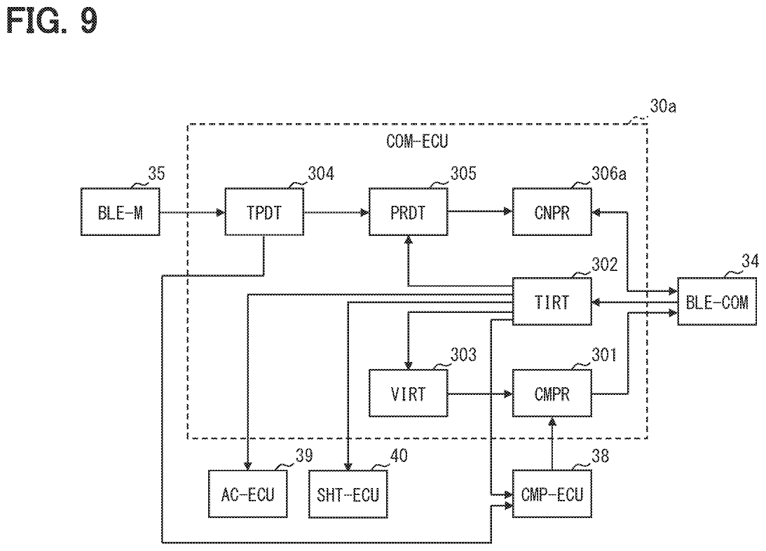

Here, an example of a schematic configuration of the communication ECU 30a will be described with reference to FIG. 9. The communication ECU 30a includes the communication processing unit 301, the terminal information acquisition unit 302, the vehicle information acquisition unit 303, the terminal position determination unit 304, the priority determination unit 305, and a connection processing unit 306a as functional blocks provided by at least one processor, The communication ECU 30a is the same as the communication ECU 30 of the first embodiment except for a connection processing unit 306a is provided instead of the connection processing unit 306.

The connection processing unit 306a establishes a communication connection between the BLE communication unit 34 and the mobile terminal 2 to perform wireless communication. The connection processing unit 306a establishes a plurality of communication connections with the mobile terminals up to the predetermined number. The connection processing unit 306a does not permit communication connections exceeding the predetermined number. The predetermined number referred to here may be the same as that of the first embodiment. The connection processing unit 306a sets a connection time period and a disconnection time period for each one of the mobile terminals 2, which are establishing the communication connections. The connection processing unit 306a sets a longer connection time period for the mobile terminal 2 which is higher ranked among the mobile terminals, The connection processing unit 306a also sets a shorter disconnection time period for the mobile terminal 2 which is higher ranked among the mobile terminals. The connection processing unit 306a sets a shorter connection time period for the mobile terminal 2 which is lower ranked among the mobile terminals. The connection processing unit 306a also sets a longer disconnection time period for the mobile terminal 2 which is lower ranked among the mobile terminals. The lower the rank in the priority order is, the shorter the connection time period is obtained. The lower the rank in the priority order is, the longer the disconnection time period is obtained. A connection processing step also corresponds to a step performed by the connection processing unit 306a to connect the mobile terminal 2, which has a higher priority, in a prevailing manner.

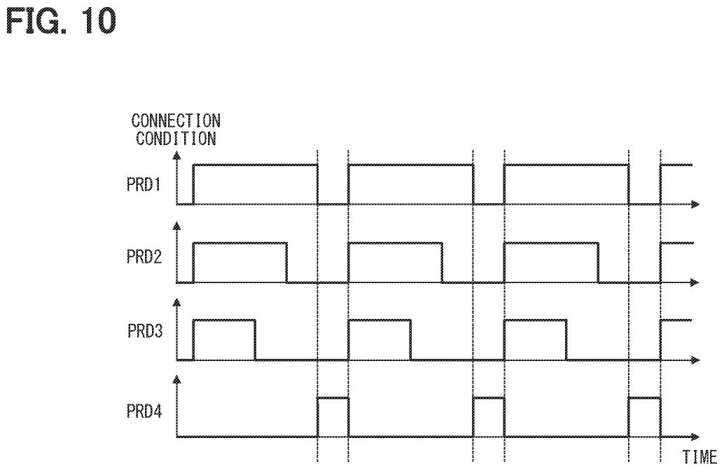

A specific example of the processing in the connection processing unit 306a will be described with reference to FIG. 10. The vertical axis shows the connection status of the communication connection. The horizontal axis shows time. In this drawing, for convenience, the predetermined number is 3, and an example is shown in a case where the number of mobile terminals 2 requesting the communication connection is 4. The substantial connectable terminal number is 4. Further, the priority determination unit 305 determines the priority order of each of 4 mobile terminals 2. For example, the four mobile terminals 2 correspond to the highest rank in the priority order (PRD1), the second rank in the priority order (PRD2), the third rank in the priority order (PRD3), and the lowest rank in the priority order (PRD4), respectively. As for the priority order, PRD1 is the highest. The rank in the priority order is PRD1>PRD2>PRD3>PRD4.

For example, the connection processing unit 306a sets 4 seconds for a connection time period for continuously maintaining the communication connection for PRD1. The connection processing unit 306a sets 1 second for a disconnection time period for continuously disconnecting the communication connection for PRD1. The connection processing unit 306a sets 3 seconds for a connection time period for continuously maintaining the communication connection for PRD2. The connection processing unit 306a sets 2 seconds for a disconnection time period for continuously disconnecting the communication connection for PRD2. The connection processing unit 306a sets 2 seconds for a connection time period for continuously maintaining the communication connection for PRD3. The connection processing unit 306a sets 3 seconds for a disconnection time period for continuously disconnecting the communication connection for PRD3. The connection processing unit 306a sets 1 second for a connection time period for continuously maintaining the communication connection for PRD4. The connection processing unit 306a sets 4 seconds for a disconnection time period for continuously disconnecting the communication connection for PRD4.

The connection processing unit 306a establishes the communication connection for the mobile terminal 2 of PRD4, during 1 second disconnection time of the communication connection of the mobile terminal 2 of PRD1. On the other hand, the connection processing unit 306a disconnects the communication connection for the mobile terminal 2 of PRD4, during 4 seconds connection time of the communication connection of the mobile terminal 2 of PRD1. As a result, it is possible to provide an opportunity to establish the communication connection among the number of mobile terminals 2 exceeding the predetermined number by shifting the communication connection time for each terminal. It is possible to keep the substantial connectable terminal number of mobile terminals 2 equal to or lower than the predetermined number.

In this configuration, the predetermined number is 3, Since a group of the mobile terminals 2 establish the communication connections in a time division manner, it is possible to provide the communication connections in a time division manner more than the predetermined number. In this embodiment, the system just permits to establish the communication connections up to 4 via 3 communication connection channels. At least one channel is available for a multi-connections in a time division manner. The multi-connections are available for a group of the mobile terminals 2, which is a pair of mobile terminals 2, i.e., a pair of PRD1 and PRD4. The group of the mobile terminals 2, i.e., the pair of PRD1 and PRD4, are substantially connectable at the same time by using a time division method. Therefore, in this embodiment, the predetermined number is 3, and the substantial connectable terminal number is 4 allowed by the time division manner. As a result, the predetermined number is smaller than the substantial connectable terminal number.

Also in the configuration of the second embodiment, the connection processing unit 306a connects the mobile terminal 2, which has a higher priority determined by the priority determination unit 305, in a prevailing manner. Therefore, even if the substantial connectable terminal number is smaller than a number of potential users of the vehicle, it is possible to provide a communication connection to a mobile terminal 2, which is a mobile terminal 2 held by a user who is assumed to need a communication connection more than the others, in a prevailing manner.

### Third Embodiment

In the above-described embodiment, the radio waves used for wireless communication for establishing the communication connection between the vehicle side unit 3 and the mobile terminal 2 and the radio waves used for determining the terminal positions are radio waves used in the same communication technology. The scope of disclosure is not necessarily limited to this. For example, radio waves used for wireless communication performed by establishing the communication connection between the vehicle side unit 3 and the mobile terminals 2 and radio waves used for determining the terminal positions may be used in different communication technologies. This example is a third embodiment described below. In the third example, two or more different communication technologies are used to provide a plurality of radio waves for both the communication connection purpose and the priority order determining purpose.

An example of a configuration of the third embodiment may use both the BLE and a UWB-IR (Ultra-Wide-Band-Impulse Radio). The wireless communication performed by establishing a communication connection between the vehicle side unit 3 and the mobile terminal 2 is provided by he BLE-compliant communication. On the other hand, the terminal positions are determined by UWB-IR communication (hereinafter referred to as UWB communication), In this case, the mobile terminal 2 may be configured to be capable of transmitting an impulse-shaped radio wave (hereinafter, an impulse signal) used in UWB communication. Further, the vehicle side unit 3 may be configured to include a communication module (hereinafter, a UWB module) for receiving the impulse signal used in the UWB communication instead of the BLE module 35. The impulse signal used in UWB communication is a signal having an extremely short pulse width of, for example, 2 nanoseconds. UWB communication is sometimes called a ultra-wideband communication. The frequency bands that can be used for UWB communication are, for example, 3.2 GHz to 10.6 GHz, 3.4 GHz to 4.8 GHz, 7.25 GHz to 10.6 GHz, and 22 GHz to 29 GHz, and the like.

The configuration of the third embodiment is, in many parts, similar to the configuration of the first and second embodiments. In the third embodiment, the terminal position determining unit 304 determines the positions of the mobile terminals 2 with respect to the subject vehicle based on a reception result received by the UWB module instead of the reception result received by the BLE module 35. When the position of the mobile terminal 2 with respect to the subject vehicle is determined based on the reception result received by the UWB module, the position may be determined by using the above-mentioned AoA method, TDOA method, or the like.

### Fourth Embodiment

In the above-described embodiment, the ranges for determining the priority order depending on the terminal positions are divided into the vehicle inside, the vicinity range, the boundary range, and the middle range. The scope of disclosure is not necessarily limited to this. For example, it may be configured to divide another ranges. For example, ranges for which different priority order is determined depending on the terminal position may be divided into two ranges, the inside and the outside.

### Fifth Embodiment

In the above-described embodiment, the priority determination unit 305 determines the priority order according to the terminal positions of the mobile terminals 2 and the presence or absence of the reception of the vehicle control request related information. The scope of disclosure is not necessarily limited to this. For example, the priority determination unit 305 may determine the priority order according only to the terminal positions of the mobile terminals 2 among the terminal positions of the mobile terminals 2 and the presence or absence of the reception of the vehicle control request related information. Alternatively, the priority determination unit 305 may determine the priority order according only to the presence or absence of the reception of the vehicle control request related information among the terminal positions of the mobile terminals 2 and the presence or absence of the reception of the vehicle control request related information.

In the first embodiment, a configuration is shown in which the position of the mobile terminal 2 with respect to the reference point of the vehicle is determined by the principle of triangulation using the maximum RSSI for three of the plurality of BLE modules 35. The scope of disclosure is not necessarily limited to this. For example, the area where the mobile terminal 2 is located may be narrowed down and determined based on whether or not the maximum RSSI for at least one BLE module 35 is equal to or greater than the threshold value.

### Sixth Embodiment

In the above-described embodiment, the communication ECU 30 is used to determine the positions of the mobile terminals 2 and determine the priority order of the mobile terminals 2. The scope of disclosure is not necessarily limited to this. For example, at least one of the determination of the positions of the mobile terminals 2 and the determination of the priority order of the mobile terminal 2 may be performed by another electronic control unit such as the comparing ECU 38. Further, the determination of the position of the mobile terminal 2 and the determination of the priority order of the mobile terminal 2 may be performed by an electronic control unit which is configured by integrating the communication ECU 30 and the comparing ECU 38.

As described above, it is understood that the following technical disclosure are at least disclosed.

Disclosure 1: An in-vehicle device, comprising: at least one processor which is configured to: establishing a plurality of communication connection with a first group of mobile terminals among a plurality of mobile terminals; performing wireless communication via the communication connections; determining a priority order among a plurality of mobile terminals, wherein the priority order is determined based on priority order determination information which is obtained by receiving radio waves transmitted from a plurality of mobile terminals by at least one antenna provided on a vehicle; and establishing a plurality of communication connection with a second group of mobile terminals including at least one mobile terminal which is different from the first group of mobile terminals and is ranked higher in the priority order than at least one of the first group of mobile terminals.

Disclosure 2: The in-vehicle device in the Disclosure 1, wherein the mobile terminal is configured to function as a key of the vehicle, and wherein the priority order determination information is terminal positions of the plurality of mobile terminals, and wherein the terminal positions are determined based on reception results of the radio waves, and wherein the priority order is determined based on the terminal positions.

Disclosure 3: The in-vehicle device in the Disclosure 2, wherein the priority order is determined so that the mobile terminal located on an inside of the vehicle is ranked higher than the mobile terminal located on an outside of the vehicle.

Disclosure 4: The in-vehicle device in the Disclosure 2 or 3, wherein the priority order is determined so that the mobile terminal located on a vicinity range, which is within a predetermined distance from the vehicle, is ranked higher than the mobile terminal located on an outside range, which is on an outside of the vicinity range.

Disclosure 5: The in-vehicle device in the Disclosure 4, wherein the priority order is determined so that the mobile terminal located on a boundary range, which is a predetermined annular range, is ranked higher than the mobile terminal located on a range on an inside of the boundary range.

Disclosure 6: The in-vehicle device in any one of the Disclosure 1-5, wherein the priority order determination information is a control request related information transmitted from the mobile terminal when an input is detected at the mobile terminal, and wherein the priority order is determined so that the mobile terminal transmitted control request related information, is ranked highest.

Disclosure 7: The in-vehicle device in any one of the Disclosure 1-6, wherein establishing a plurality of communication connections with the first group of mobile terminals up to a predetermined number, and wherein when the first group of mobile terminals reaches the predetermined number, and at least one new mobile terminal requests to establish at least one new communication connection, and wherein (i) if any one of previously connected mobile terminal is ranked lower than the new mobile terminal, establish the new communication connection with the new mobile terminal after cancelling one of the communication connections with the previously connected mobile terminal of which the priority order is ranked lowest among the previously connected mobile terminals, and (ii) if any one of previously connected mobile terminal is not ranked lower than the new mobile terminal, maintain the communication connections with the previously connected mobile terminals.

Disclosure 8: The in-vehicle device in the Disclosure 7, wherein the predetermined number is equal to a substantial connectable terminal number which is a number of mobile terminals capable of substantially establishing the communication connection.

Disclosure 9: The in-vehicle device in the Disclosure 7, wherein the predetermined number is smaller than a substantial connectable terminal number which is a number of mobile terminals capable of substantially establishing the communication connection.

Disclosure 10: The in-vehicle device in any one of the Disclosure 1-6, wherein the communication connection with the mobile terminal ranked higher in the priority order is set to maintain a connection time period longer and a disconnection time period shorter than the other mobile terminal ranked lower in the priority order, and wherein a number of the communication connections never exceed a predetermined number.

Disclosure 11. A system for a vehicle, comprising: a mobile terminal carried by a user; an antenna disposed on a vehicle; and the in-vehicle device in any one of the Disclosure 1-10.

Disclosure 12: A method for managing terminal connection, executed by at least one processor comprising the steps of: establishing a plurality of communication connection with a first group of mobile terminals among a plurality of mobile terminals; performing wireless communication via the communication connections; determining a priority order among a plurality of mobile terminals, wherein the priority order is determined based on priority order determination information which is obtained by receiving radio waves transmitted from a plurality of mobile terminals by at least one antenna provided on a vehicle; and establishing a plurality of communication connection with a second group of mobile terminals including at least one mobile terminal which is different from the first group of mobile terminals and is ranked higher in the priority order than at least one of the first group of mobile terminals.

The present disclosure is not limited to the above-described embodiment, The disclosure can be modified in various ways within the scope of the claims. Embodiments obtained by appropriately combining the technical means disclosed in the different embodiments are also included in the technical scope of this disclosure. The control portion and the method therefor which have been described in the present disclosure may be also realized by a dedicated computer which constitutes a processor programmed to execute one or more functions concretized by computer programs. Also, the device and the method therefor which have been described in the present disclosure may be also realized by a special purpose hardware logic circuit. Alternatively, the device and the method described in the present disclosure may be implemented by one or more special purpose computers configured by a combination of a processor executing a computer program and one or more hardware logic circuits. The computer program may be stored, as instructions to be executed by a computer, in a tangible non-transitory computer-readable medium.

What claimed is:

1. An in-vehicle device, comprising: at least one processor which is configured to:
establishing a plurality of communication connection with a first group of mobile terminals among a plurality of mobile terminals;
performing wireless communication via the communication connections:
determining a priority order among a plurality of mobile terminals, wherein the priority order is determined based on priority order determination information which is obtained by receiving radio waves transmitted from a plurality of mobile terminals by at least one antenna provided on a vehicle; and
establishing a plurality of communication connection with a second group of mobile terminals including at least one mobile terminal which is different from the first group of mobile terminals and is ranked higher in the priority order than at least one of the first group of mobile terminals.

2. The in-vehicle device claimed in claim 1, wherein
the mobile terminal is configured to function as a key of the vehicle, and wherein
the priority order determination information is terminal positions of the plurality of mobile terminals, and wherein
the terminal positions are determined based on reception results of the radio waves, and wherein
the priority order is determined based on the terminal positions.

3. The in-vehicle device claimed in claim 2, wherein
the priority order is determined so that the mobile terminal located on an inside of the vehicle is ranked higher than the mobile terminal located on an outside of the vehicle.

4. The in-vehicle device claimed in claim 2, wherein
the priority order is determined so that the mobile terminal located on a vicinity range, which is within a predetermined distance from the vehicle, is ranked higher than the mobile terminal located on an outside range, which is on an outside of the vicinity range.

5. The in-vehicle device claimed in claim 4, wherein
the priority order is determined so that the mobile terminal located on a boundary range, which is a predetermined annular range, is ranked higher than the mobile terminal located on a range on an inside of the boundary range.

6. The in-vehicle device claimed in claim 1, wherein
the priority order determination information is a control request related information transmitted from the mobile terminal when an input is detected at the mobile terminal, and wherein
the priority order is determined so that the mobile terminal transmitted control request related information, is ranked highest.

7. The in-vehicle device claimed in claim 1, wherein
establishing a plurality of communication connections with the first group of mobile terminals up to a predetermined number, and wherein
when the first group of mobile terminals reaches the predetermined number, and at least one new mobile terminal requests to establish at least one new communication connection, and wherein
(i) if any one of previously connected mobile terminal is ranked lower than the new mobile terminal, establish the new communication connection with the new mobile terminal after cancelling one of the communication connections with the previously connected mobile terminal of which the priority order is ranked lowest among the previously connected mobile terminals, and
(ii) if any one of previously connected mobile terminal is not ranked lower than the new mobile terminal, maintain the communication connections with the previously connected mobile terminals.

8. The in-vehicle device claimed in claim 7, wherein
the predetermined number is equal to a substantial connectable terminal number which is a number of mobile terminals capable of substantially establishing the communication connection.

9. The in-vehicle device claimed in claim 7, wherein
the predetermined number is smaller than a substantial connectable terminal number which is a number of mobile terminals capable of substantially establishing the communication connection.

10. The in-vehicle device claimed in claim 1, wherein
the communication connection with the mobile terminal ranked higher in the priority order is set to maintain a connection time period longer and a disconnection time period shorter than the other mobile terminal ranked lower in the priority order, and wherein a number of the communication connections never exceed a predetermined number.

11. A system for a vehicle, comprising:
a mobile terminal carried by a user;
an antenna disposed on a vehicle; and
the in-vehicle device claimed in claim 1.

12. A method for managing terminal connection, executed by at least one processor comprising the steps of:
establishing a plurality of communication connection with a first group of mobile terminals among a plurality of mobile terminals;
performing wireless communication via the communication connections;
determining a priority order among a plurality of mobile terminals, wherein the priority order is determined based on priority order determination information which is obtained by receiving radio waves transmitted from a plurality of mobile terminals by at least one antenna provided on a vehicle; and
establishing a plurality of communication connection with a second group of mobile terminals including at least one mobile terminal which is different from the first group of mobile terminals and is ranked higher in the priority order than at least one of the first group of mobile terminals.
